(19) United States
(12) Patent Application Publication
(10) Pub. No.: US 2005/0246436 A1
(43) Pub. Date: Nov. 3, 2005

(54) System for registering, locating, and identifying network equipment

(75) Inventors: Robert Day, Mountain View, CA (US); Josh LeVasseur, Sunnyvale, CA (US); Raymond Suorsa, Los Gatos, CA (US)

Correspondence Address: BUCHANAN INGERSOLL PC;(INCLUDING BURNS, DOANE, SWECKER & MATHIS), POST OFFICE BOX 1404, ALEXANDRIA, VA, 22313-1404, US

(73) Assignee: LOUDCLOUD, INC., Sunnyvale, CA (US)

(21) Appl. No.: 11/061,749

(22) Filed: Feb. 18, 2005

Related U.S. Application Data
(63) Continuation of application No. 09/761,769, filed on Jan. 18, 2001, now abandoned.

(51) Int. Cl. G06F 15/173

(52) U.S. Cl. 709/223

(57) ABSTRACT

The present invention is directed toward providing a system for registering, locating, and identifying network servers within a data center containing many such servers. Parallel and serial port couplers with an erasable, programable read-only memory are encoded with a unique ID number, and a label with a bar code corresponding to the ID number is affixed to each coupler. A server to be installed in a data center has an encoded coupler attached to one of its communication ports, and information related to that particular server is stored in a system database. Upon encountering a problem with a network server, the system displays the logical name of the server at issue. The location and identification information for the server are retrieved from the system database and displayed to a technician responsible for the server at issue. Using the displayed location information, the technician reads the label on the coupler connected to the suspected server and verifies that the ID number on the coupler matches the ID number displayed for the server requiring service.

### CROSS-REFERENCE TO RELATED APPLICATION

This application is related to copending, commonly assigned United States nonprovisional application Ser. No. 09/632,796 filed Aug. 4, 2000, the disclosure of which is incorporated herein by reference.

### BACKGROUND OF THE INVENTION

1. Field of the Invention

The present invention relates generally to identifying equipment in a data center, and more particularly, to registering, locating, and identifying individual network servers among a plurality of servers maintained within a large data center.

2. Description of the Related Art

Early data processing services were provided by technically focused data centers which were physically proximate to the respective non-technical users of the data centers. Gradually, communication networks were established whereby users physically remote from the data center could be connected to the data center through hard-wired telephone lines and coaxial cables to access the resources and services available through the data center. Often these early remote users were connected to the data center through dedicated modems and network controllers located in the data center and reserved for use by specific sets of users. As communication technology evolved and as more and more users were connected to the data center for remote access, the physical size of these network controllers decreased while their versatility for providing flexible, on-demand access to data center resources increased. Today, literally tens of millions of users are connected to a plurality of data centers world-wide through various public and private networks, most notably the Internet. The connection between these remote users and the computers of the various data centers is provided through server computers, with the larger data centers, or “server farms,” containing thousands of servers.

Each server has a physical identity, such as a chassis or CPU serial number, and also a logical internet protocol (“IP”) address through which the network accesses and controls the server. Individual servers may also be broadly designated by a logical “server name,” which can be any logical reference by which the server may be designated, such as the server's logical IP address, its hostname, or a functional identification. However, unlike personal computers, servers often lack a keyboard or a display with which to query and identify the particular server. Furthermore, serial numbers may be located inside the server housing and therefore be difficult to access or view by a technician; or may be on the motherboard or the network interface card, which may be replaceable during the life of the server. In any event, data centers and remote users typically perceive each server through one of its logical server names because the logical server name is a reliable, logical identifier through which the computers connected to the server communicate to the various remote users. Therefore, when operational software, a user, or data center personnel detect a possible error or malfunction associated with a server, the problematic server can often only be identified by its logical server name, which generally has no nexus to the server's physical location or identification in the data center. When a technician is sent to find a particular server to perform maintenance, make changes to the cabling of the server, or remove or replace the server, the technician is looking for a particular server corresponding to a specific logical server name. The logical server name, which can change or be reassigned during the operational life of the server, is not discernable from the exterior of the server, and does not correspond to the physical location of the server within the data center. Absent a map indicating the server's location, the technician has no way of locating the server at issue. Even when the technician locates what he or she believes to be the server in question, there is no way to know for certain by looking at the server that the server at hand corresponds to the logical server name the technician is supposed to service.

Some data centers address this problem by maintaining a manual cross-reference chart or map of physical location and logical names for all servers. In other words, the chart or map shows both where the server is located in the room (such as by rows and racks) and the logical server name through which the network communicates with the server or by which the data center refers to the server. These charts and maps are generally drawn when new servers are added to the data center, and their respective logical server names are established at their initial connection to and startup within the network. However, charts and maps can be unreliable for correctly identifying a particular server because the association between the logical name of the server and the manually-maintained chart or map could either be out of date or could have been incorrectly entered during creation of the chart or map. Servers are often added to the data center, moved around the data center, or swapped with other servers without the chart or map being updated, and data center personnel can inadvertently transpose address numbers when logging the initial or changed location of servers. Typically the process of logging the addition or relocation of a server within a data center is a manual process, with the technician manually writing or entering the server's serial number, owner, application, date of installation/relocation, etc. Not only is this process prone to error and the misentry of information, it is also time-consuming and may actually delay bringing a server online, especially in rapidly growing server farms that may experience server additions and changes numbering in the hundreds every day.

For all of these reasons, actually locating the server at issue for purposes of diagnosing and resolving a server problem or performing scheduled maintenance or determining real-time or historical usage can be a difficult, time-consuming, and imprecise task. As a result, in some instances, servers become “lost” among the thousands of servers in a data center. In other words, the data center personnel have no means whereby they can identify these sought servers in the data center. While the percentage of “lost” servers within a data center may be small, the actual number of such inaccessible servers may be in the dozens, or even hundreds. These lost servers can be monitoring servers, application servers, or database servers—the loss of any of which can be damaging to the data center and the users that are attempting to access the resources of the data center through its various servers.

Furthermore, even when a data center technician locates what he or she believes to be the problem server, no means presently exist by merely looking at the server to verify that the server corresponds to the logical name of the server at issue. Even if the logical server name is affixed to the exterior of the server, the ease by which logical server names may be changed causes an uncertainty as to whether the external markings on the server are both up to date and accurate. Therefore, if the technician begins working on a server without first verifying that it has the targeted logical server name, the data center runs the risk of taking down an active, functioning server and thereby severing the active connection of one or more users and potentially crashing an entire Internet web site. Furthermore, in addition to severing the connection to potentially thousands of users, taking down the wrong server could result in the irrecoverable loss of important data that is being transmitted through the server. Additionally, the technician often must interface manually with other resources and files within the data center to implement server-related commands, such as changing the IP address of the server, reboot the server, or perform a network test of the server.

Accordingly, it would be desirable to provide a registration, location, and identification system that could dynamically furnish data center personnel with the physical identification of a network server within a data center from the server's logical name. It would be desirable to provide a registration system whereby new and relocated servers could be accurately and efficiently recorded in a registry and queried so that the servers can be easily identified, maintained, and queried. Further, it would be desirable to provide an equipment location system for physically locating a particular device within a facility housing many such devices. Additionally, it would also be desirable to provide an equipment verification system to ensure that a particular server has the logical server name being sought.

The preferred embodiments of the present invention overcome the problems associated with existing mechanisms for registering, locating, and identifying network equipment within a data center.

### SUMMARY OF THE INVENTION

The present invention is directed toward a method and apparatus for registering, locating, identifying, and querying servers located in a data center. A hand-held controller or scanner is used by data center personnel to interface between the servers located in the data center and related data center files maintained with server-related information such as owner (customer), application, usage, type, and location. While the hand-held controller includes a laser scanner for reading bar code labels, this device is more appropriately termed a controller because it also has a wireless input/output port for transmitting information and commands and also for receiving information.

The present invention is implemented by use of a small device for connecting to a port of a server which is to be installed in a data center and including a programmable memory portion that is encoded with a unique identifier (“ID number”), which may be numeric or alphanumeric. This device is referred to as a “coupler” because the device is attached, or coupled, to one of the ports of the server, such as a parallel, serial, or universal serial bus (“USB”) input/output (“I/O”) port. A visual indication of the unique identifier, such as a bar code, is also provided on the outside casing of the coupler. A driver is loaded into the software of the server that permits the server to query the memory of the coupler. Information related to the server, including the ID number of the coupler attached to the server, is stored in a central database, thereby registering the server in the data center.

As a further feature of the present invention, the information stored in the central database provides a link between the logical IP name of a server and the physical location of that server to assist a technician in locating a particular server in the data center. Upon determining that a particular server requires attention, the present system queries the central database and displays to a technician the location and unique identifier (first-displayed) information associated with the server. The technician then proceeds to the server in question, based on the displayed location information. As an additional feature, the present invention permits the positive verification of the identity of the server at hand. In this mode, the hand-held controller is utilized to read the unique identifier affixed to the coupler attached to the server and displays the result of the scan to the technician. If the controller-displayed identifier matches the first-displayed identifier information, the technician can be assured that the server at issue has been located.

In an alternative embodiment of the invention, the logical server name of the server is also stored in the memory of the coupler attached to a server. Upon determining that a server requires attention (first logical server name), a technician proceeds to the server in question based on location information gleaned from the central database and queries the contents of the memory of the coupler attached to the server for the stored logical server name (second logical server name). If the first and second logical server names match, the technician can verify that he or she has identified the server requiring attention.

### BRIEF DESCRIPTION OF THE DRAWINGS

These and other objects and advantages of the present invention will become more apparent and more readily appreciated from the following description of the preferred embodiments, taken in conjunction with the accompanying drawings, of which:

FIG. 1 illustrates a block representation of a logical server network within which an embodiment of the present invention functions.

FIG. 2 shows a rack of network servers within a data center.

FIG. 3 shows the apparatus of an embodiment of the server identification system of the present invention.

FIG. 4 shows the operational features and controls of a hand-held controller of the present invention.

FIG. 5 shows the logon display of the controller.

FIG. 6 is a block diagram of the method of initializing a coupler with a unique identification number.

FIG. 7 shows the apparatus for initializing the couplers according to an embodiment of the present invention.

FIG. 8 is a block diagram of the method of installing an initialized coupler on a server in a data center and registering the server in the data center.

FIG. 9 is a block diagram of the method of locating and identifying a server in a data center by the ID number of the coupler attached to the server.

FIG. 10 shows the apparatus for identifying a server in a data center by either the ID number of the coupler attached to the server or the logical server name of the server.

FIG. 11 shows the display of a map of the data center on the controller.

FIG. 12 shows the display of the controller when ready to scan an identifier of a server.

FIGS. 13 and 14 show the display of server-related information as received from a data center database.

FIG. 15 shows the display of the controller when ready to receive server location information.

FIG. 16 is a block diagram of an alternative embodiment of identifying a server in a data center by the logical server name of the server.

### DETAILED DESCRIPTION OF THE PREFERRED EMBODIMENTS

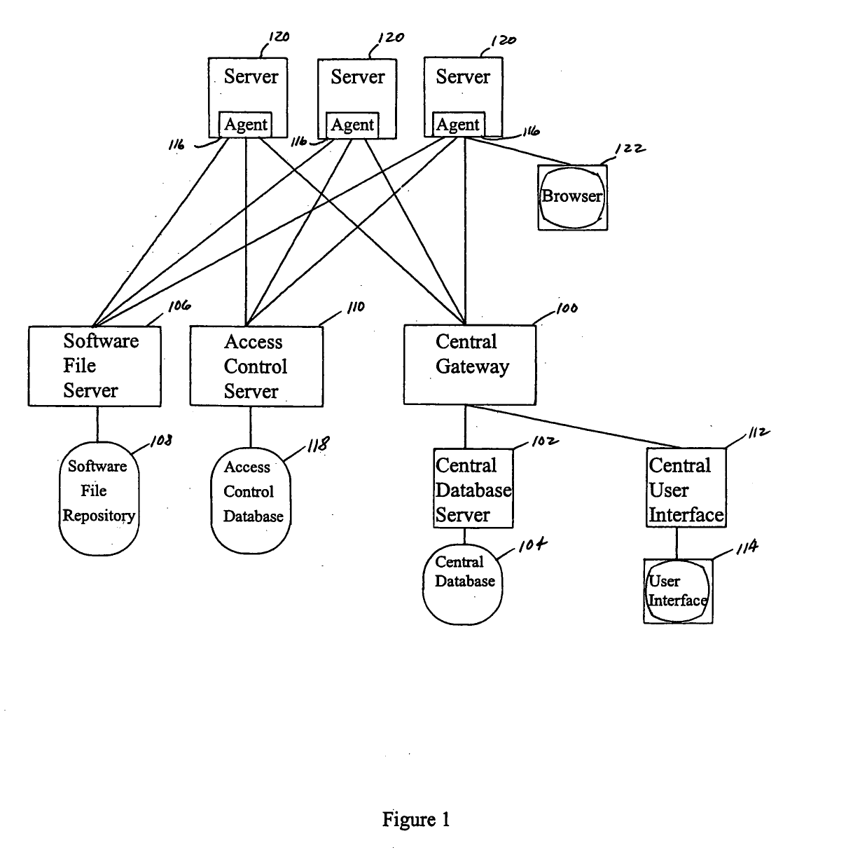

Referring now to FIG. 1, there is illustrated a block representation of an exemplary logical server network within which the present invention functions. The structure of the network as displayed in FIG. 1 is representative of the multi-layered server/database architecture that is supported by the present invention. An access-control server called the central gateway 100 is the interface through which servers, users, and applications communicate and access software and information on the network. As the primary control processor of the network, the central gateway 100 talks to and is talked to by each of the elements of the network. For example, a remote user accessing the network through one of the servers 120 and requesting information stored on a central database 104 managed by the central database server 102 will have the request routed through the central gateway 100 for clearance. An approved request may proceed to access information through the central database server 102 or may result in a command being issued by the central gateway 100 for the user or application to access information or a software application through the access server 110 or the software file server 106, respectively. In such a manner, network resource access is controlled for purposes of convenience, security, and managing authorized access.

As presently configured, the network shown in FIG. 1 represents a physically localized network in that all servers and databases 100-120 are geographically proximate to each other. However, the application of the present invention is not limited to such a physical restriction, and the elements of FIG. 1 may just as easily be scattered physically across the globe without detracting from the inventive elements, methods, and functions of the present invention.

The central database server 102 is a server that manages all knowledge, or information, relating to the network and each of its components. Examples of such information include the logical server name and the physical identifier of each customer server 120, the customer to whom each server 120 is allocated, the type and model of the server 120, the applications available and authorized to operate on a particular server 120, usage information per server 120, and the physical location of a server 120 in a data center. Accessible to the central database server 102 are one or more relational databases 104 for storing and retrieving the network's knowledge. Within the present specification, information will be disclosed as being “stored” on the central database server 102 or “accessible” through the central database server 102. In practice, such information, or network knowledge, may be stored on and accessible from either the actual database(s) 104 or memory within the central database server 102 itself, and the present disclosure does not distinguish between the two storage locations. Software packages and applications are managed by the software file server 106 and are stored on one or more software file repositories 108. As with the information managed by the central database server 102, the software managed by the software file server 106 may be stored on either the software file server 106 itself or on one of the software file repositories 108, and the functionality of the present invention is not affected by where the software is physically stored. At one level within the software file server 106, the software packages are managed within a hierarchy by customer. In this manner, all applications related to a particular customer can be identified, managed, restricted, moved, and/or deleted. Any request to access or invoke a software package is routed through the central gateway 100 to verify not only that the package exists on the network but also that the user/server is authorized and configured to access the software. The actual determination of what user has what access is routed to and decided by the access control server 110. The access control server 110 maintains a hierarchical directory of user information for both data center personnel and customers to control proper access by all users to devices, software, and information under control of the access control server 110, and thereby, the central gateway 100. This user information includes personnel attributes, authority, whether the user is a customer or works in the data center, machines authorized to access, and functional authority and is stored on one or more access control databases 118 under the control of the access control server 110.

The user interface server 112 provides user access to internal network components, including access through graphical user interfaces 114. The user interface server 112 is configured to provide access for authorized personnel, often data center developmental personnel, to implement new or changed procedures and software. Provisioning, or initializing and loading, of each server is accomplished through the user interface server 112. User access to network resources is provided through one or more servers 120. Associated with each customer server 120 is an agent 116 for communicating between the server 120 and the central gateway 100 for facilitating user/server 120 access to the software of the software file server 106, access control information of the access control server 110, and the data managed by the central database server 102. Each agent 116 periodically reports through the central gateway 100 to the central database server 102 the condition and configuration of its respective server 120. In this manner server 120 usage information is captured and is routed through the central gateway 100 for storage on the central database 104. Each of the servers 120 has one or more user interfaces in the form of browsers 122 that permit users to access the servers 120 and, through the servers 100, 106, and 110, the resources of the network. One environment in which the network shown in FIG. 1 exists is the Internet. While the present invention is directed at registering and managing network servers within a data center, the present inventive system could also be applied to any device with a processor within a data center or affiliated with a network without detracting from the inventive features disclosed herein.

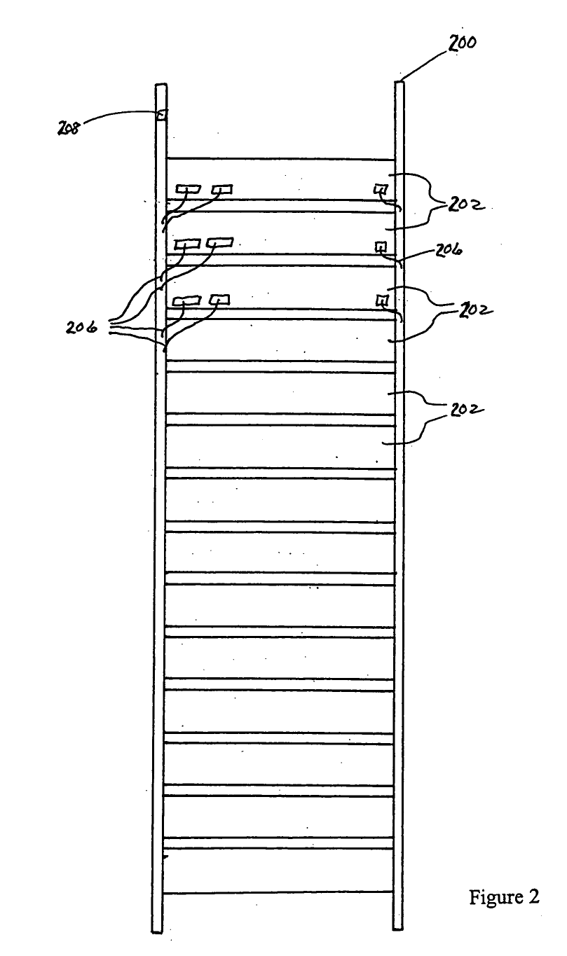

Referring now to FIG. 2, there is shown an exemplary rack 200 of network servers 202 located in a data center, such as servers providing user connections to the Internet. Typically, the servers 202 are bolted to and supported by the sides of the server rack 200, with each rack supporting one or more servers 202. Cabling 206 is provided to and from each server 202 to provide for electrical power, control signaling, and I/O communication. In a large data center, hundreds of server racks 200 of this type may be present, to accommodate several thousand servers. Each server rack 200 may have one or more server rack labels 208 affixed, with each label 208 being imprinted with an identifier for uniquely identifying the server rack. The identifier may be in the form of a printed number, a printed alphanumeric identifier, a printed bar code that can be mechanically read by a bar code reader, a transponder that can be electronically excited and read, or any combination of the four. The identifier may merely identify the particular rack or could comprise comprehensive server rack information, including data center identifier, building number, building floor, cage, row, rack, quadrant, server placement, and customer information. The quadrant information may be of the format A, B, C, and D or 1, 2, 3, and 4 and represents the quadrant of the rack 200 in which the server 202 resides. The server placement information may be expressed in the form of distance, rack units, or relative position from the bottom or top of the rack.

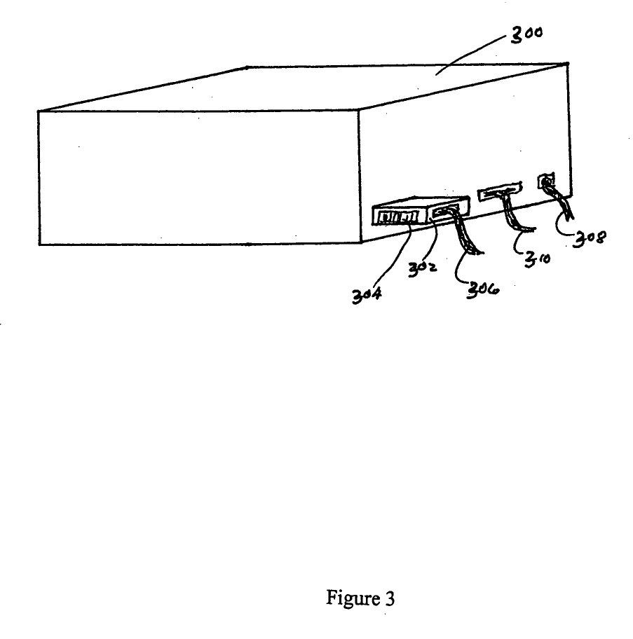

Referring now to FIG. 3, there is illustrated the apparatus of a preferred embodiment of the invention. Each server 300 has connected to one of its ports, such as a parallel, serial, or USB port, a coupler 302 containing a programmable memory chip (not shown). Affixed on at least one side of the coupler 302 is a label 304 containing a unique identifier (unique, at least, to the particular data center or particular section within a data center where the server 300 is located). Although shown on the side of the coupler 302 in FIG. 3, the label 304 may be placed on any side of the coupler 302 as long as the label 304 is accessible and viewable by a technician. The unique identifier may be numeric or alphanumeric; and, preferably, the unique identifier includes a bar code or similar form of information that facilitates automated reading by a scanner or the like. The identifier can also be configured, in size, content, and placement, for visual verification by an operator or technician. Optionally connected to the side of the coupler 302 away from the server 300 is the appropriate cable 306 providing communications to and from the server 300, if required. Also connected to the server 300 is at least one power cord 308 and one network cable 310.

One implementation of the invention utilizes either of two devices from Rainbow Technologies of Irvine, Calif. as the aforementioned couplers, each of which has an erasable, programmable read-only memory (“EEPROM”). The SentinelSuperPro™ is utilized to attach to those servers having parallel ports. The MicroSentinelUX™ is used on servers with serial ports. The intended and marketed purpose of the Sentinel devices from Rainbow is software piracy protection. In its intended environment, the EEPROM memory of the Sentinel devices is encoded with a unique software identifier number, and the devices are delivered to users with a purchased software product. To use the software on the user's computer, the Sentinel device must be first connected to a communication port of the computer. The purchased software, upon execution, queries the Sentinel to determine not only that the Sentinel device is installed but also that a number encoded in the Sentinel's memory matches the number coded in the software package (or which has been entered by the computer's user from the software's license agreement document). This query and verification often occurs periodically during execution of the purchased software to ensure the Sentinel device has not been removed and installed on a second computer to enable the second computer to run a pirated copy of the software. If the software does not locate the Sentinel, or if the number in the Sentinel's memory does not match the number stored with the software, the software does not execute.

In contrast to this intended use of the Sentinel devices, the present use of the Sentinel devices is to provide electronic storage of the unique identifier which appears on the exterior surface of the coupler and, thereby, an identification of the server to which the coupler is connected. Rather than being queried every time a particular program is utilized, as in the Sentinel application, the coupler is queried on demand, whenever there is a need to know the unique identifier associated with the server. It will be appreciated that the present invention is not limited to the use of the Sentinel devices from Rainbow Technologies and could be utilized with any such coupler with a memory component accessible by the server to provide a unique identifier. Furthermore, it is conceivable that a single coupler with several ports, such as a parallel port, a serial port, and a USB port, could be successfully utilized in the present invention.

Additionally, in an alternate embodiment of the invention, the aforementioned coupler 302 can be eliminated, and the label 304 containing a unique identifier can be affixed to the chassis or casing of the server 300. In this embodiment, the communications cable 306 is connected directly to a port of the server 300. Clearly, the absence of the coupler 302 would eliminate the feature of storing the unique identifier in the memory of the coupler 302, and the present system would rely on scanning the unique identifier rather than also being able to access an ID number stored in the memory of the coupler 302. However, as an additional feature of this embodiment, the unique identifier can be stored in the memory of the server 300 and can be accessible therefrom. Alternatively, the identifying label 304 need not be affixed to either the coupler 302 or the server 300 and could be an identifier in the form of a tag that is clipped, tied, or otherwise associated with either the coupler 304 or the server 302. In such an embodiment, the identifier can be said to be “associated” with the coupler 304 or the server 300 without being physically affixed to either component. Similarly, with the advent of wireless technology, the coupler 304 need not be physically attached to the server 300 in order for the inventive system to be completely functional as described above and below. In such an embodiment, the coupler 304 can be viewed as being “associated” with the server 300 for which the coupler 304 provides identification features.

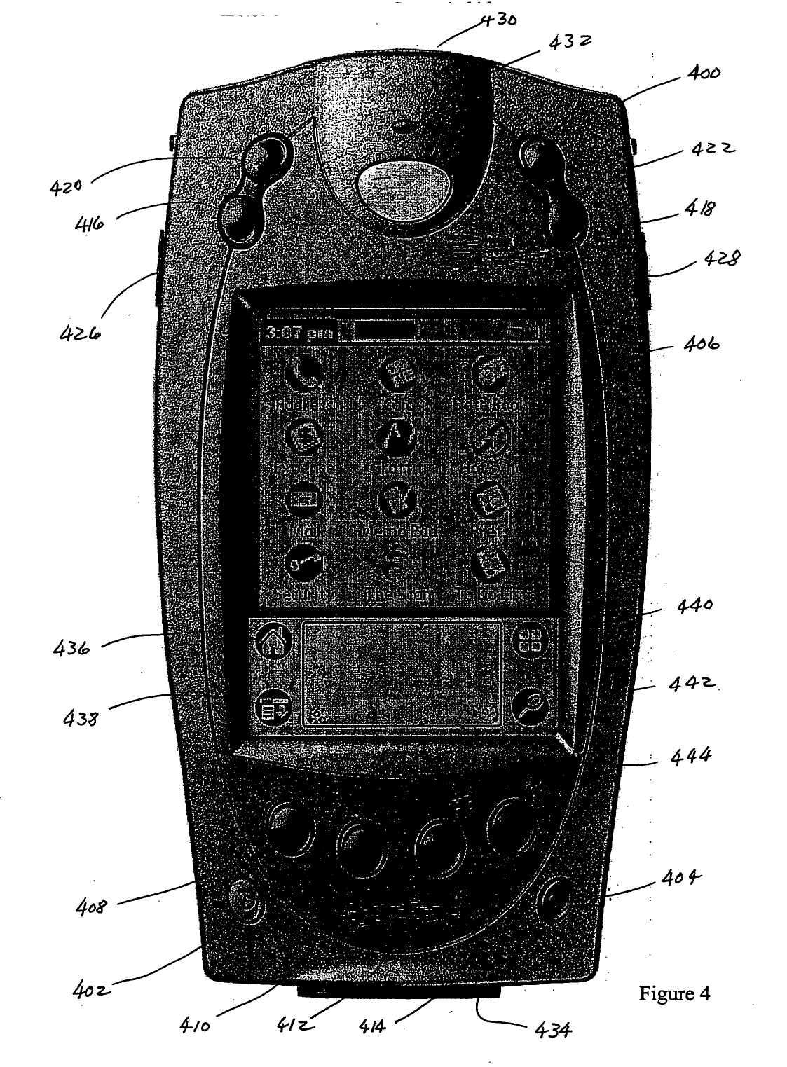

Referring now to FIG. 4, there is shown the controller device 400 of the present invention. One example of a scanner which can be employed as the controller device 400 is a programmed SPT 1740 hand-held scanner from Symbol Technologies, Inc. of Holtsville, N.Y. The SPT 1740 conveniently permits the scanning of the a bar code affixed to each coupler and the subsequent wireless transmission of identification and location information to the central database server for matching with the ID number/IP address information. However, any scanner with storage and/or transmission features could be utilized without detracting from the present invention.

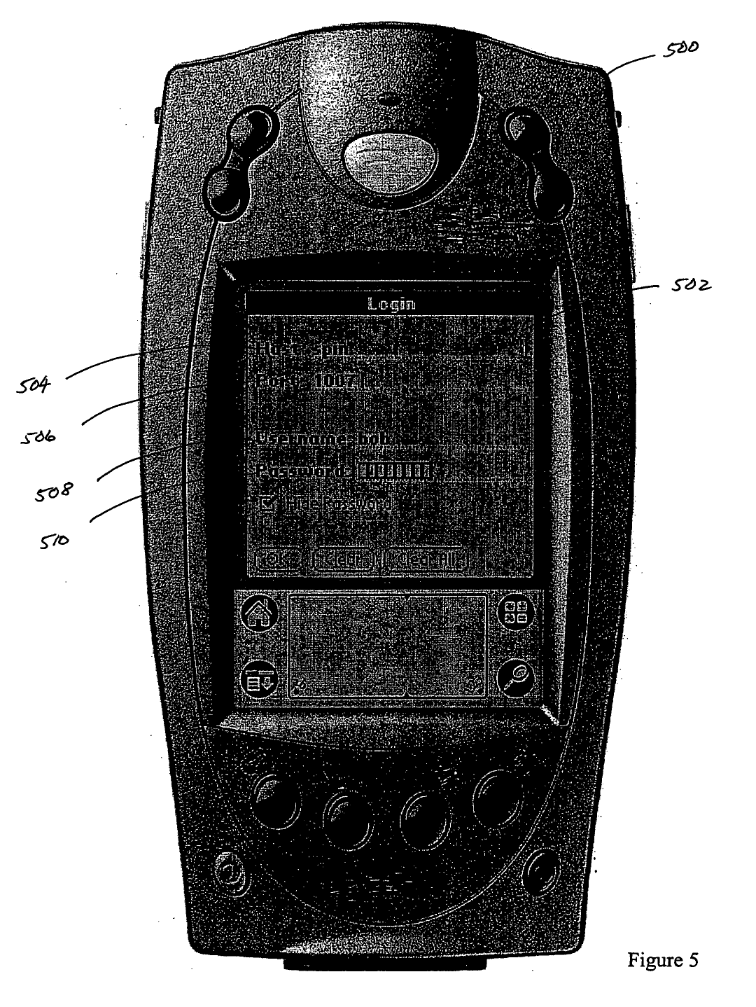

The control, communication, and display elements of the controller device 400 are as follows: The controller 400 is powered on and off by depressing button 402. The controller 400 will power down automatically after a period of non-use to save battery life. If subsequently powered up from an automatic power down, the controller 400 remembers the user id, password, and authority level that were in place when the device powered off. Button 404 controls the contrast of the display 406. Buttons 408, 410, and 412 respectively invoke the calendar/appointments, address/phone list, and to do list functions. As can be seen from the display 406, each of these functions and more can also be invoked through the touch screen 406. Button 414 displays on screen 406 a logon screen for the user to enter an id and password, as shown in FIG. 5. Buttons 416 and 418 control scrolling the image on the display 406 down, and buttons 420 and 422 control scrolling up. Buttons 424, 426, and 428 can each activate the laser scanner 430, which, when activated, illuminates the LED 432. The controller 400 can connect to a serial port through connector 434 for the exchange of data. Additionally, although not shown in FIG. 4, the controller 400 can communicate wirelessly to transmit and receive information. In the present embodiment, the controller 400 can transmit to an Ethernet. However, the present invention is not limited to a particular wireless network or protocol. In fact, the controller 400 can transmit either short or long distances to communicate with a server 300, a coupler 302, or various devices on the network. In this manner, communication can be established and information transmitted to and from the server 300 and/or the coupler 302, including when the network is unable to communicate with the server 300.

A menu for additional functions can be invoked by depressing button 436. A drop-down list of frequently used options can be displayed by depressing button 438. These options include logging out, preferences, version, keyboard, and graffiti. Upon selecting the last option, display 444 can be utilized to enter information. Similarly, the keyboard option will display a miniature keyboard for the entry of information into the controller 400 for storage, transmittal, or commands. Button 440 displays a calculator on the display 444, and button 442 invokes a location entry option.

Use of the controller 400 device in the present invention beyond its capabilities as a personal digital assistant requires the user login with a id and a password. Referring now to FIGS. 4 and 5, FIG. 5 shows the controller 500 with the login screen 502 being displayed to the user, with the present screen displaying the username 508, or id, of Bob having already been entered by the user. Upon receiving the id 508 and password 510 as entered or keyed in by the user, the controller 500 initiates a wireless connection through a base networking bridge between a wireless network and a wired local area network (not shown) to verify the entered information. Through this bridge, the controller application communicates with the access control server 110 to determine whether the id/password is valid and what hierarchical level of access is authorized for that user. The logical name of the host server to which the controller 500 is connected is displayed at 504, as is the port 506 through which the controller 500 is connected to the host server. A table of valid users, each with a corresponding level of authority, is maintained on the access control database 118 as managed by the access control server 110. The access control server 110 communicates back to the controller 500 the results of the logon verification. If the logon verification fails, an error message is displayed on the screen 502, and the scan and communication features of the controller 500 are disabled, thereby restricting the user from any scan or communication access. Additionally, the controller 500 restricts display of the available menus based on the level of user authority, thereby preventing the user access to functions, devices, and software that are beyond the authority of the user. If the logon is successful, the access control server 110 signals the controller 500 the level of functional authority available to the user, based on the logon/authority table maintained on the access control database 118. The controller 500 informs the user that the logon has been successful by means of a displayed message on the screen 502. The user can logout of the system from any screen display by tapping the pull down menu button 436 and selecting “Logout.” Any and all signals to and from the controller 500 may be encrypted by any of several well-known encryption techniques to further the security of the present inventive system.

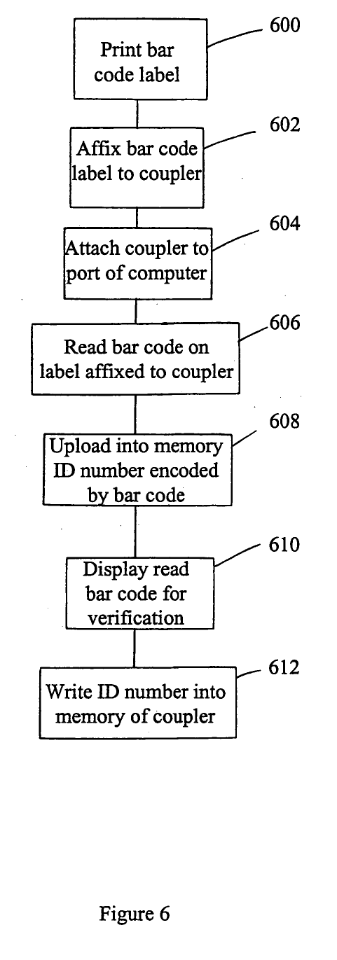

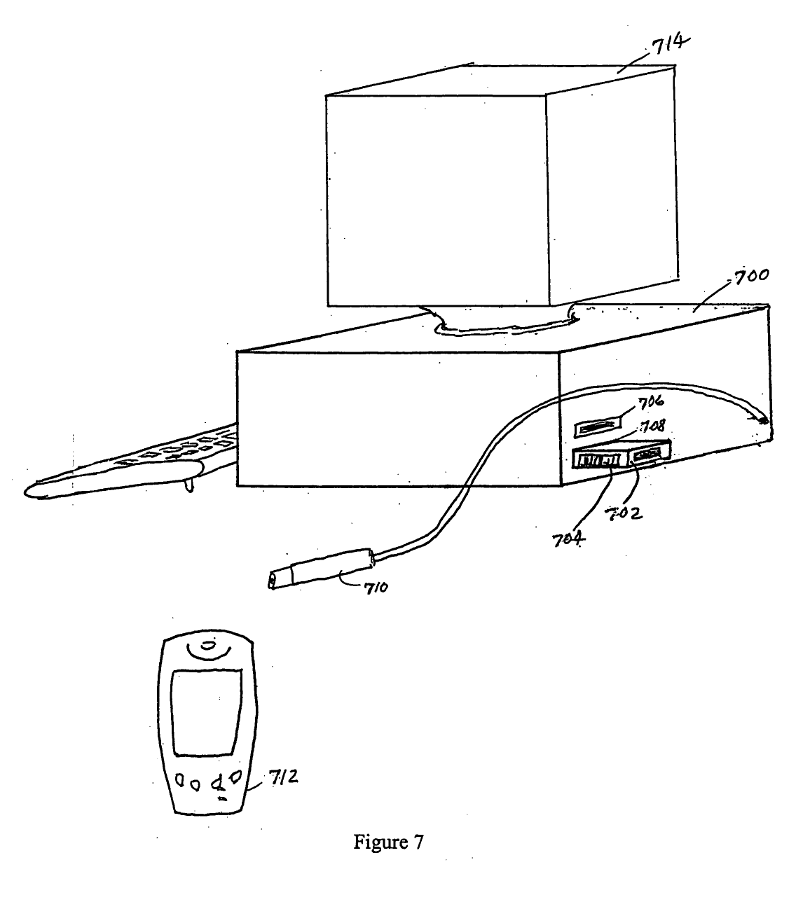

The process of initializing the coupler 302 is shown in the flow chart of FIG. 6, and the apparatus for initializing the couplers with a unique ID number is shown in FIG. 7. As discussed above in reference to FIG. 3, this process can be skipped in the alternate embodiment of the invention in which the label 304 is affixed to or associated with the server 300 in the absence of a coupler 302. However, as also discussed above, in the absence of the coupler 302, the memory of the server 300 can be initialized with the unique ID number.

Typically, in the preferred embodiment, a large quantity of couplers 702 are initialized at a time, for later association with servers as the servers are installed in a data center. Referring now to FIGS. 6 and 7, at step 600, adhesive bar code labels 704 are printed such that each label has a unique ID number, which can be in the form of a bar code and/or an alphanumeric listing of the ID number. In one embodiment of the invention, a seven (7) digit ID number can be employed because this size number works well with a scannable bar code. However, any number with sufficient digits to be unique can be used as long as the number can be stored in the memory of the coupler. Each label 704 is affixed to a coupler 702 at step 602 such that the label 704 can be read while the coupler 702 is attached to the server. Although FIG. 7 shows a single label 704 on the side of the coupler 702, the label 704 can be affixed to any visible surface of the coupler 702. As an alternative, a pair of bar code labels 704 are printed with a matching unique bar code, and each of the pair of matching labels 704 is affixed to a coupler 702. As an additional feature of the present invention, the coupler 702 could come already supplied, imprinted, embossed, or stamped with an ID number, thereby eliminating the need for printing and affixing the coupler 702 with an ID number label 704. As discussed above regarding FIG. 3, an alternate embodiment of the invention provides for an identifier to be “associated” with the coupler 702 without being affixed to the coupler 702.

At step 604, the coupler 702 is attached to the parallel port 706 or serial port 708 of an initialization computer 700, depending on which type of coupler 702 is being initialized (including, optionally, any other I/O port, such as an USB port, which is not shown in FIG. 7). A wand 710 connected to the computer 700 is used to read the bar code on the coupler 702 at step 606 and upload the ID number encoded by the bar code label 704 into the memory of the computer 700 at step 608. The read ID number is also displayed to the technician on the computer's monitor 714 at step 610 for verification against the number printed on the bar code label 704. In an alternative embodiment, the controller 712 can be utilized to scan the bar code label 704 on the coupler 702. The scanned ID number would be displayed on the screen 406 (see FIG. 4) of the controller 712 for immediate verification. The ID number can then be transmitted by the controller 712 to the computer 700, either through the controller's wireless communication features or serial port 434. At step 612 the computer 700 writes the ID number into the memory of the coupler 702, thus initializing the memory of the coupler 702 with the unique bar-coded ID number affixed to the outside casing of the coupler 702. The ID number is preferably “burned” into the EEPROM memory such that the memory contents can not be later modified. Depending upon the amount of memory in the coupler, additional data can be stored as well. For instance, the memory may contain the initialization date in YYYYMMDD format and the time in HHMMSS format. A second copy of the unique ID can be stored, along with a longitudinal redundancy check digit of the data.

If desired, the computer 700 can encrypt the ID number prior to initializing the memory of the coupler 702. The encryption could be done, for example, by a mathematical algorithm. The encryption could also be accomplished by having unique and separate ID's for the physical identifier for the coupler (and, thereby, the server to which the coupler is connected) and the logical identifier for the server, with a one-to-one mapping. Such a mapping would need to be accessible by a technician querying the coupler. By encrypting the ID number, a data center utilizing the couplers on its servers is better safeguarded against unauthorized access to its server configurations and network information. For example, with an unencrypted unique ID number, a hacker could potentially determine which server contained certain information (such as credit card information) and could then locate that server in the data center using the coupler. Encrypting the ID number protects against such unauthorized activity.

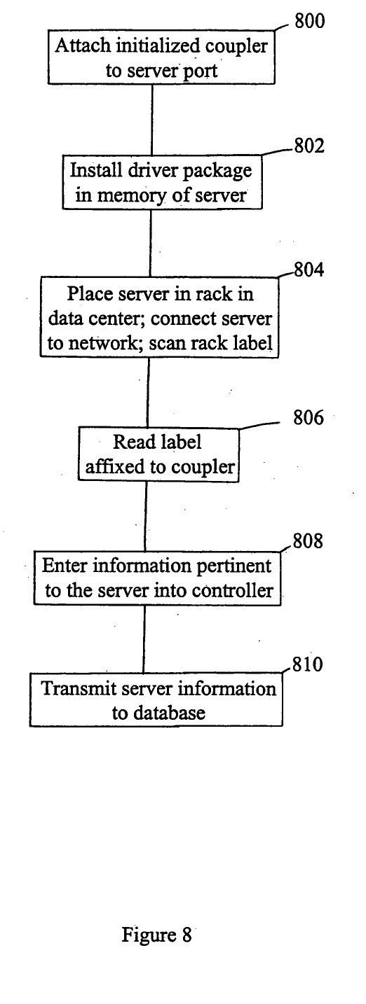

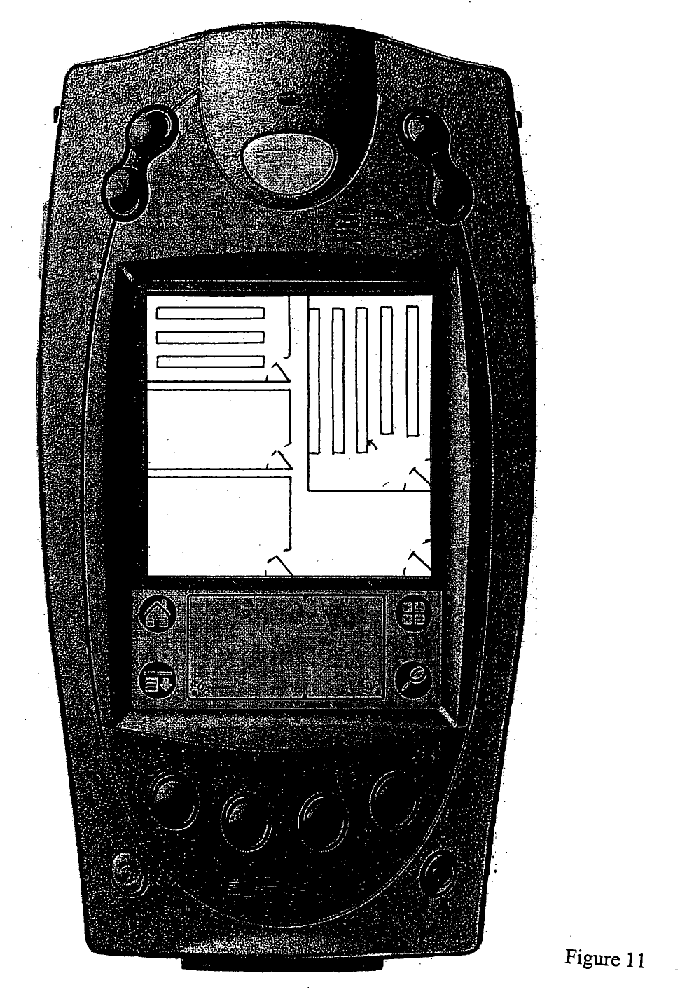

Referring now to FIG. 8, there is shown a flow chart of the installation of the initialized couplers on data center servers and the subsequent registration of the servers in the data center. Upon adding a server to the data center, an initialized coupler of the appropriate port configuration is attached to one of the server's I/O ports at step 800. A driver software package is also installed in the memory or storage of the server at step 802 to provide the ability to access the contents of the memory of the coupler. Steps 800 and 802 could just as effectively be performed in reverse order without detracting from the effectiveness of the present invention. Furthermore, either of steps 800 and 802 may occur before, while, or after the server is installed in the data center. For example, a “lost” server located in the data center could be retrofitted by installing a new coupler. At step 804, the server with the attached coupler is placed in its appropriate server rack location within the data center, is physically connected to the network, and the server rack label is scanned by the controller, including the appropriate actual or relative location in the rack where the server has been placed. In the absence of any server rack labels within the data center, the user can enter the rack and server location information manually through the 444 screen of the controller 400 of FIG. 4. The entry of location information can be accomplished by inputting actual location data, such as row number, rack number, and relative rack position number. Alternatively, the technician may use a stylus or similar device to designate on a displayed map of the data center (see FIG. 11), including an image of the server rack, precisely where the server has been placed. At step 806, the label affixed to the coupler attached to the server is read by the controller. As discussed above, in an alternate embodiment of the invention, the label is affixed to the server in the absence of a coupler. In this alternate embodiment, steps 800 and 802 are skipped, and the label to be read in step 806 is affixed to the server instead of the coupler. Additionally, in the preferred embodiment, the user can enter into the controller at step 808 other pertinent information related to the server, such as logical server name, customer name, role or application of the server (such as web server, application server, database server, central database server, software file server, or central gateway), type of server (manufacturer, model, serial number), status (embryo, baby, or production), hostname, port, IP address, description, and miscellaneous notes). The scanned server rack label, the ID label information, and any user-entered information are automatically transmitted by the controller to the central database server via the central gateway at step 810 to create an entry, indexed by the ID number on the coupler, in the central database 104 for the server. As an additional feature, the server-related information can also be maintained completely or in part in the memory of the controller.

In addition to being able to designate the location of a server on a displayed map of the data center, the technician also has the ability through the controller to create a map of the data center. Although not shown in the present Figures, this feature includes a menu of images the technician can select from either of the screens 406 or 444 representative of equipment or facilities typically found in a data center. Once entered or partially entered on the controller by the technician, the data center map can be transmitted by the controller for storage via the central database server for subsequent access, editing, or display.

As a further feature of the present invention, the logical server name may also be stored in the memory of the coupler (or in the memory of the server in the absence of the coupler in an alternate embodiment of the invention). In this version of the invention, upon initial start-up of the server and connection to the network at step 804, the installed driver in the server writes the logical name of the server into rewritable memory of the coupler. At this point, the present system has provided a tight mapping between a logical identifier and a physical identifier for the server, thereby “binding” the two identifiers together for later use in identifying the server. Additional information regarding the server may be transmitted to the controller or the central database server at this time and periodically while the server is active, including the server's type, memory capacity, configuration, interface card types and addresses, hard drive capacity, operating system, loaded software, media access control address of Ethernet card (MAC address), domain name of host to which server is connected (i.e., hostname), and server port. Whenever the server boots up, it automatically inventories its hardware and software and communicates through the central gateway to update the central database, based on ID number of the coupler attached to the server.

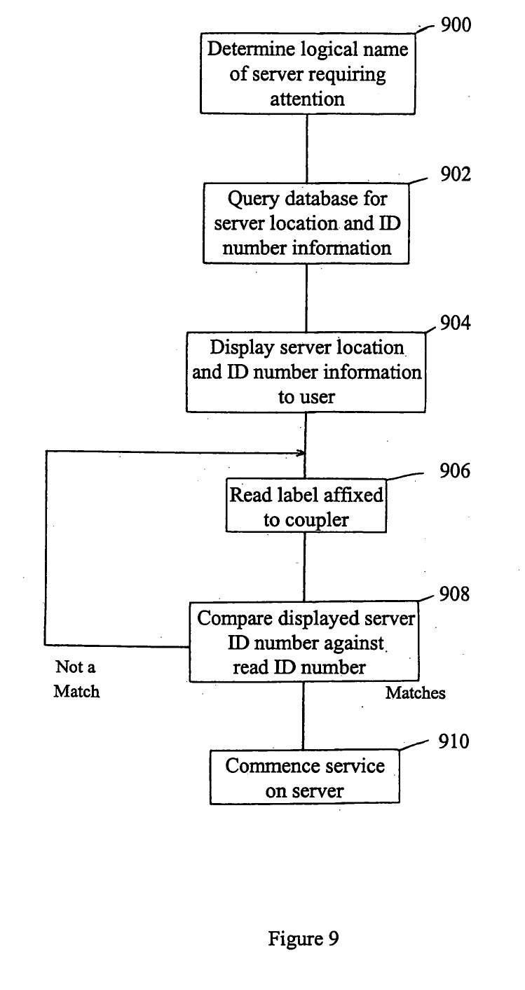

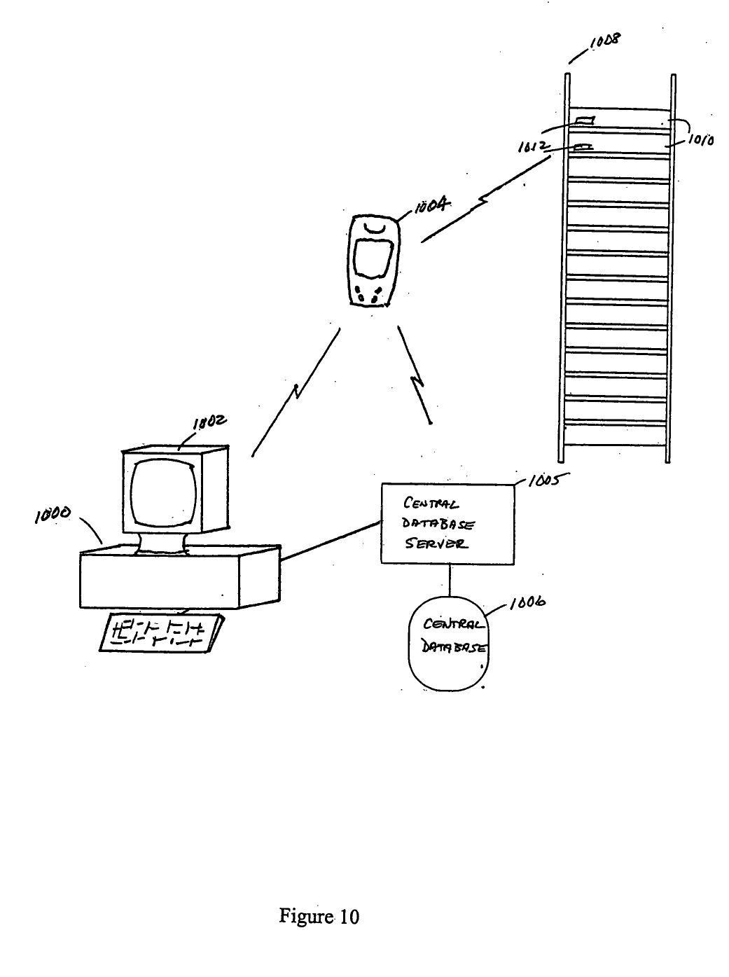

The actual process of locating and identifying a server within a data center by use of the present invention is shown in FIG. 9, with the apparatus for the process shown in FIG. 10 At step 900, a technician determines the logical name of a server 1010 requiring attention or intervention, possibly by being so informed through a message displayed on a monitor 1002 connected to the network system processor 1000. The determination that the particular server 1010 requires attention or intervention could arise from a communications problem with that particular server 1010, periodic maintenance being called for, a user connected through the server 1010 calling in to report an access problem, etc. The technician requests at step 902 the processor 1000 query the central database 1006, through the central database server 1005, for location and coupler ID number information, based on the displayed logical name of the server 1010. In response, the central database server 1005, via the central gateway (not shown), displays at step 904 the corresponding information to the technician on the display 1002. Alternatively, the central database server 1005 could transmit the requested information directly to the controller 1004 for display on its screen 406 (see FIG. 4). In either case, the central database server 1005 could also transmit a map of the data center (see FIG. 11), with the server's location highlighted, to facilitate the process of locating the server in the data center. Additionally, the central database server 1005 could transmit any of the information stored for the server 1010, including the server's current application, the customer name, the role of the server, the type of the server, and the status of the server. As an additional feature, the above server-related information can be maintained in and available from the memory of the controller 1004.

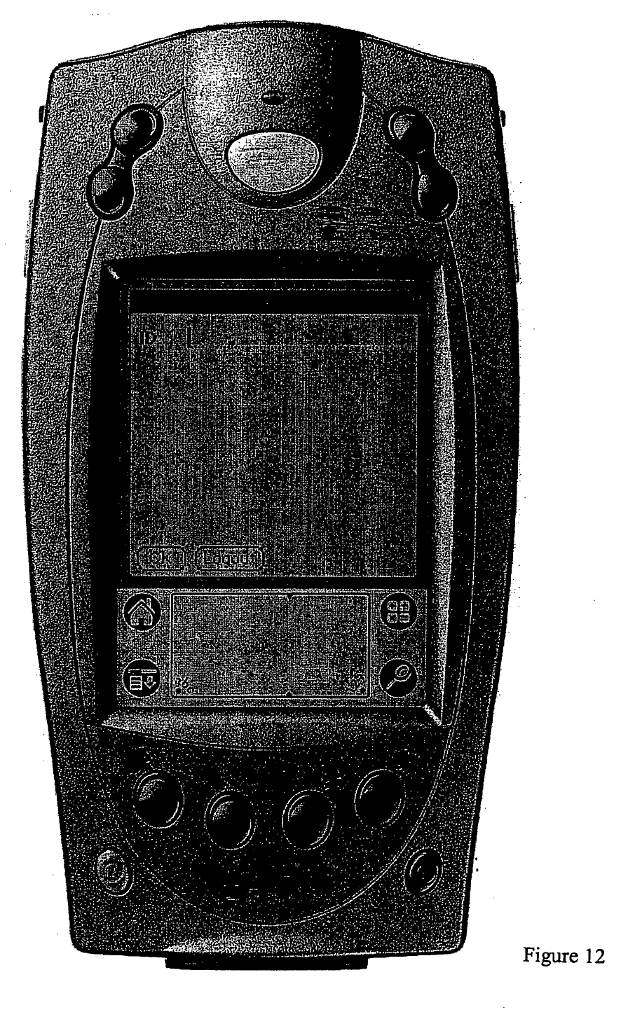

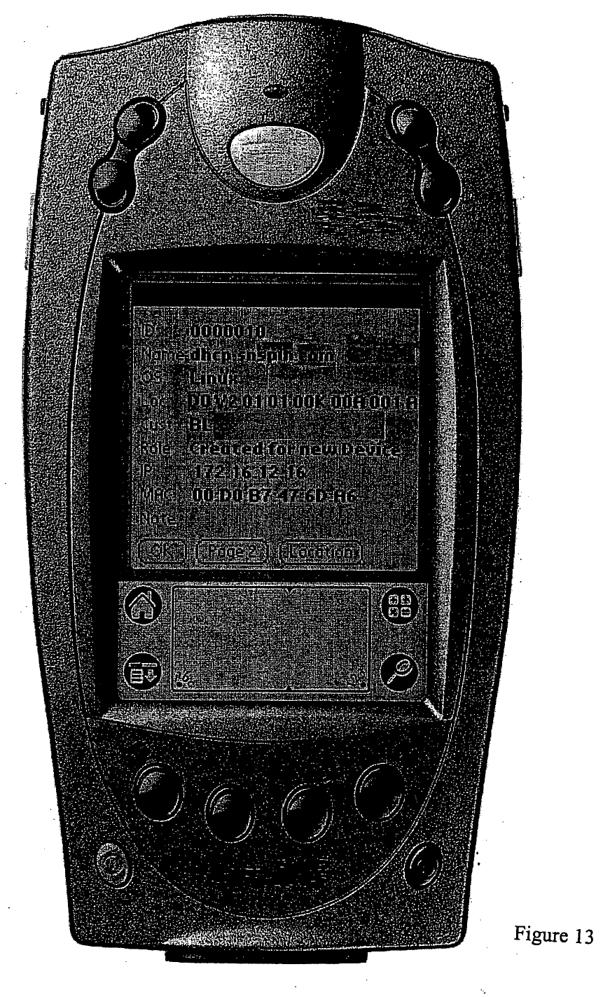

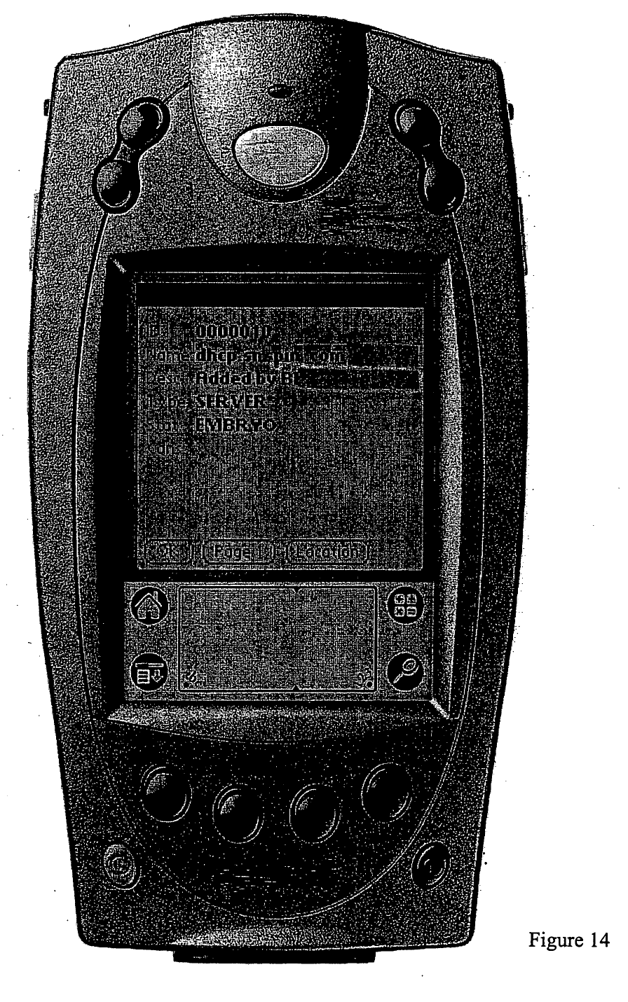

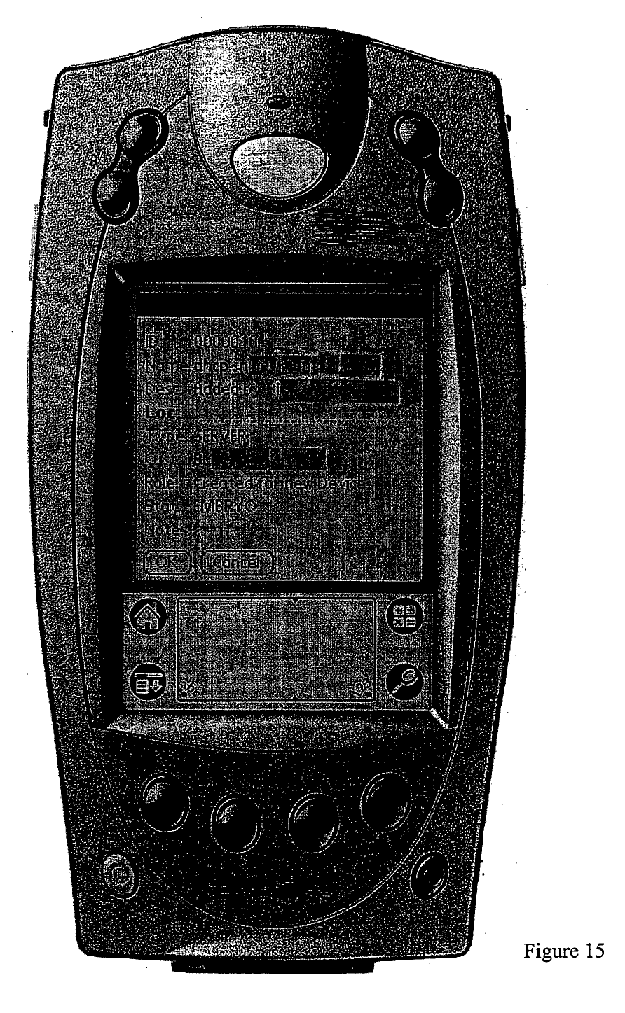

The technician utilizes the displayed location information from the central database server 1005 to locate the server 1010 in question, whether the information has been gleaned from the display 1002 or the controller 1004. The controller 1004 is used at step 906 by the technician to read the label affixed to the coupler 1012 attached to the server 1010 and display to the technician the read bar code or the like. In an alternate embodiment of the invention discussed above that eliminates the use of the coupler 1012, a label affixed to the server 1010 is read by the controller 1004 instead of a label affixed to a coupler 1012. Referring now to FIG. 12, there is shown a configuration of the controller 1004 in a receiving mode ready to read the unique identifier through its scanner 430 (see FIG. 4). Upon reading the ID number affixed to the coupler 1012 on the server 1010 (or affixed to the server 1010 itself in an alternate embodiment discussed above), the controller 1004 transmits a request for information to its server, which then queries the central database server 1005 via the central gateway (not shown). Depending upon the controller's preference settings, the request can be sent to the central database server 1005 immediately when scanned, or when the OK button shown in FIG. 12 is pressed. The latter option is useful if there is significant radio interference in the data center. If the server 1010 is in a location that the radio signal does not reach, the technician can scan the coupler's ID number and then return to an area of radio coverage before pressing OK. The server-related information is transmitted from the central database server 1005 to the controller 1004, where it is displayed as shown in FIGS. 13 and 14. The technician can toggle back and forth between the first page of the information display as shown in FIG. 13 and the second page as shown in FIG. 14 by tapping the “page 1”/“page 2” button. The technician has the option of updating the location information if the server 1010 has been moved, either by scanning the server rack label at the new location, manually entering the new rack location by tapping the location button 442 (see FIGS. 4 and 15), or designating on a map of the data center the new server location. When the location button 442 is pressed, the location update screen as shown in FIG. 15 appears. The technician can manually enter the server rack location for the server 1010 if no rack bar code label is available to scan. Pressing the OK button will cause the controller 1010 to transmit the new location information to the central database server 1005 via the central gateway for updating the server-related information stored in the central database 1006. If another ID number label is scanned from the screen of FIG. 13 or FIG. 14, the information displayed will be updated with the information for the new server 1010. If the OK button is tapped, the user is returned to the ID entry screen of FIG. 12.

Referring again to FIGS. 9 and 10, at step 908, the technician compares the number displayed on the controller with the ID number originally displayed in step 904 on the system display 1002 or the controller 1004. If the numbers match, the technician can be assured that the server 1010 at hand is the server represented by the displayed logical server name as requiring attention or intervention. The technician can therefore safely proceed to step 910 and commence work on the server 1010, including taking the server 1010 down or offline. If the numbers do not match, then the technician is thereby informed that the server 1010 at hand is not the sought server, and the search for the proper server 1010 continues through steps 906 and 908 until the numbers match. Alternatively, if the location information and coupler ID number have been directly transmitted to the controller 1004 by the central database server 1005 in step 904, the controller can automatically compare the transmitted ID number against the scanned ID number and notify the technician through its display whether a match has been found. If the numbers match, the controller 1004 displays to the technician a positive indication of the match, such as a green light, or the message, “SERVER FOUND.” If the numbers do not match, the controller so displays to the technician a red light and/or the message, “SERVER NOT FOUND—DO NOT PROCEED.” Upon finding a mismatch, the controller 1004 can query the central database 1006 for the location of the server 1010 in question and for location information for the server actually scanned by the controller 1004. The controller 1004 can then display to the technician a map of the data center showing the location of the server 1010 in question relative to the position of the presently scanned server or can display express directions how the technician should proceed through the data center from his or her present location at the scanned server to the location of the server 1010 in question. Through the above described process, the identity of the server 1010 requiring attention is verified by mapping the logical network identity of the server 1010 to the physical ID number encoded in the memory of the coupler 1012 attached to the server 1010 through the databases managed by the central database server 1005. Additionally, the technician is guided by the information displayed on the hand-held controller 1004, as obtained from the central database 1006, to the proper server 1010 requiring attention.

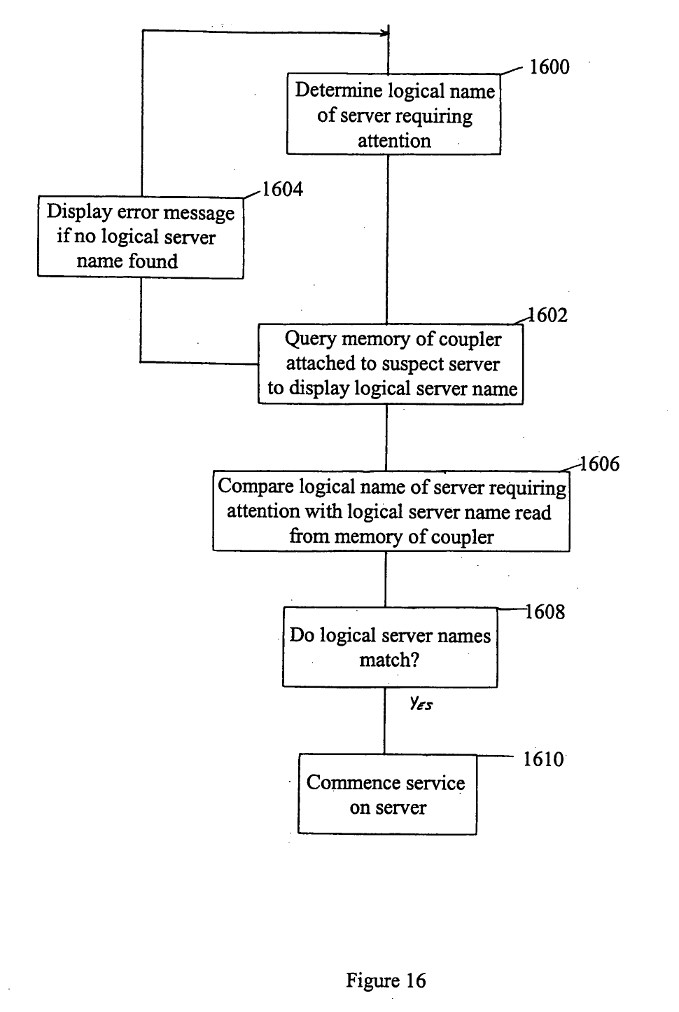

In an alternative embodiment of the invention shown in FIGS. 10 and 16, the system utilizes the logical server name stored in the memory of the coupler 1012 (or in the memory of the server 1010 in the absence of the coupler 1012) to match against a displayed logical name of a server 1010 requiring attention or intervention. In this embodiment, the system does not query the server 1010 for the ID number of the attached coupler 1012. Instead, upon determining in step 1600 that a server 1010 requires attention, the technician proceeds to the suspect server 1010 based on location information retrieved from the central database server 1005. At step 1602, the technician uses the controller 1004 to query the memory of the coupler 1012 attached to the server 1010 for the logical server name that had been stored in memory upon initial start up of the server 1010 with the network, as discussed above. To accomplish this step, the controller 1004 can communicate through its wireless connection or its serial port to the server 1010 to query the contents of the memory of the coupler 1012 through the driver stored on the server 1010. Alternatively, if the server 1010 is down or unable to connect to the controller 1004, the technician can remove the coupler 1012 from the server 1010 and directly attach it to the controller 1004 via the serial port 434, to read the data stored in the coupler 1012.

If no logical server name has been stored in the memory of the coupler, an error message is displayed at step 1604. If the controller has successfully read a logical server name, it displays the logical server name on its display, and at step 1606, the technician compares the logical server name read from the memory of the coupler 1012 and displayed on the screen of the controller 1004 against the logical name of the server requiring attention as had been displayed on display 1002 in step 1600. If the two logical server names match at step 1608, the technician can be assured that the server 1010 at hand is the server represented by the logical server name that was displayed on display 1002 as requiring attention or intervention. As discussed above regarding the flow chart of FIG. 9, the technician can then proceed to step 1610 to service the server 1010. If the logical server names do not match, then the technician can return to step 1602 to query other servers 1010 until a match is found or no more servers 1010 are available to query.

In another embodiment of the present invention, the logical server name of any server 1010 can be determined by a technician utilizing the controller 1004 as described above in step 906. Upon scanning the bar code of the coupler 1012 affixed to a server 1010 (or affixed to the server 1010 itself), the controller 1004 either queries its memory or transmits a query to the central database server 1005, searching for the scanned ID number. Upon finding a match, the controller 1004 displays to the technician the associated logical server name of the server 1010, either directly from the search within the memory of the controller 1004 or as transmitted from the central database server 1005. If no match is found, a corresponding error tone or message is emitted from or displayed on the controller 1004, indicating that the scanned ID number is not registered in the system.

In yet a further embodiment of the present invention, a multi-layered map display by the hand-held controller can display information to the technician in addition to mere location. For example, the data center map display of the controller can selectively display or highlight the locations of servers based on technician-selected parameters, such as host, customer, server model, date of server installation, application server, software application in use, servers with outstanding work order tickets, etc. Further, the technician can select a particular displayed compartment, rack, or server with the controller's stylus and can “zoom” in to display more detail regarding the selected item. For example, at one level of “zoom,” the detail shown in FIGS. 13 and 14 is shown for a selected server. Another layer of “zoom” could display directions based on a technician's registered location in the data center (“proceed straight ahead from your present location, turn right after second rows, server located fourth from the bottom in the sixth rack on the right”). These directions can also be displayed graphically to the technician in the form of arrows or other directional images on a displayed map of the data center, directing the technician where to proceed to the sought device. The technician's current location could have been designated by the technician on the controller's displayed map or could have been automatically determined by the central database server based on the last server scan of the controller held by the technician.

While the present controller has been described above in terms of its ability to interact with a back office networked system to display and verify information relating to data center servers, the controller within the present inventive system also has the ability to operate as a command device. In this mode, the controller can invoke a finite set of commands to conveniently permit a user to control a server with a hand-held controller. These commands can be accessed through the drop-down menu invoked by depressing button 438 of FIG. 4. Examples of available commands include: change the IP address of the server, change the hostname of the server, shut down the server, reboot the server, perform a network test, hostname lookup. In this embodiment, the controller interfaces with the central gateway 100 to direct the commands to the appropriate and authorized servers 120 and to receive any results from the commands for subsequent display to the user.

Although preferred embodiments of the present invention have been shown and described, it will be appreciated by those skilled in the art that changes may be made in these embodiments without departing from the principle and spirit of the invention, the scope of which is defined in the appended claims and their equivalents.

1-3. (canceled)

4. An apparatus for registering a network server, comprising:
a coupler associated with a unique identifier;
a first memory of the coupler initialized with a unique identification number associated with the unique identifier;
a network server to which the initialized coupler is associated;
a scanner reading the unique identifier; and
a second memory storing the scanned unique identifier.

5. The apparatus according to claim 4, wherein the unique identifier is a bar code label.

6. The apparatus according to claim 4, further comprising:
a second unique identifier affixed to a rack location where the network server is located, wherein the scanner reads the second unique identifier and the second memory stores the read second unique identifier as network server location information associated with the stored scanned unique identifier.

7. The apparatus according to claim 4, further comprising:
a network to which the network server is connected, wherein the logical server name of the network server is retrieved from the network and stored in the first memory.

8. The apparatus according to claim 4, wherein the scanner is a hand-held scanner requiring successful user login prior to use.

9. The apparatus according to claim 8, further comprising:
a third memory accepting an identification and a password entered during a user login, wherein the identification and password are transmitted from the third memory to the second memory, and wherein a level of authorization based on the entered identification and password is verified and the functions of the scanner are limited based on the verified authorization.

10. The apparatus according to claim 8, wherein the scanner receives information associated with the network server and transmits the received information to the second memory for storage and wherein the received information is selected from the group of server-related information, consisting of rack location, customer name, role, type, status, hostname, port, IP address, and description.

11-13. (canceled)

14. A method for registering a network server, comprising:
associating a unique identifier with a coupler;
initializing the memory of the coupler with a unique identification number associated with the unique identifier;
associating the initialized coupler with a network server;
scanning the unique identifier; and
storing the scanned unique identifier in a database.

15. The method according to claim 14, wherein the unique identifier is a bar code label.

16. The method according to claim 14, further comprising:
affixing a second unique identifier to a rack location where the network server is located;
reading the second unique identifier; and
storing the read second unique identifier in a database as network server location information associated with the stored scanned unique identifier.

17. The method according to claim 14, further comprising:
connecting the network server to a network;
retrieving the logical server name of the network server on the network; and
storing the logical server name in the memory of the coupler associated with the server.

18. The method according to claim 14, wherein the unique identifier is scanned with a hand-held scanner requiring successful user login prior to use.

19. The method according to claim 18, further comprising:
entering an identifier and password into the hand-held scanner;
transmitting the entered identifier and password to a database;
verifying a level of authorization based on the entered identifier and password; and
activating only those functions of the hand-held scanner based on the verified level of authorization.

20. The method according to claim 18, further comprising:
entering information associated with the network server into the hand-held scanner;
transmitting the entered information to the database; and
storing the transmitted entered information in the database,
wherein the entered information is selected from the group of server-related information, consisting of rack location, customer name, role, type, status, hostname, port, IP address, and description.

21-62. (canceled)

63. An apparatus for identifying a server on a network, comprising:
a unique identifier associated with a network server;
an interface retrieving the logical server name of the network server on the network;
a database storing the unique identifier data and the location data for the network server as related information;
a display displaying the unique identifier and the location information from the database for a selected network server;
a reader reading an identifier associated with a server at the displayed location; and
a processor comparing the read identifier with the displayed unique identifier for a match to verify the identity of the server at the displayed location.

64-81. (canceled)
